(19) United States
(12) Patent Application Publication
(10) Pub. No.: US 2018/0018391 A1
(43) Pub. Date: Jan. 18, 2018

(54) DATA CLASSIFICATION DEVICE, DATA CLASSIFICATION METHOD, AND NON-TRANSITORY COMPUTER READABLE STORAGE MEDIUM

(71) Applicant: YAHOO JAPAN CORPORATION, Tokyo (JP)

(72) Inventor: Nobuhiro KAJI, Tokyo (JP)

(73) Assignee: YAHOO JAPAN CORPORATION, Tokyo (JP)

(21) Appl. No.: 15/647,527

(22) Filed: Jul. 12, 2017

(30) Foreign Application Priority Data
Jul. 13, 2016 (JP) 2016-138344

(51) Int. Cl. G06F 17/30; G06N 99/00; G06F 17/13; G06F 17/16

(52) U.S. Cl. CPC G06F 17/30707; G06N 99/005; G06F 17/13; G06F 17/16

(57) ABSTRACT

A data classification device according to the present application includes a conversion unit, a classification unit, a first learning unit, and a second learning unit. The conversion unit converts input classification target data into a feature vector. The classification unit provides a label to the classification target data on the basis of the feature vector output by the conversion unit. The first learning unit learns conversion processing of the conversion unit, using accumulated data of the input classification target data, as first learning data. The second learning unit learns classification processing of the classification unit, using second learning data in which a label has been provided to data of a same type as the classification target data.

### CROSS-REFERENCE TO RELATED APPLICATION(S)

The present application claims priority to and incorporates by reference the entire contents of Japanese Patent Application No. 2016-138344 filed in Japan on Jul. 13, 2016.

### BACKGROUND OF THE INVENTION

### 1. Field of the Invention

The present invention relates to a data classification device, a data classification method, and a non-transitory computer readable storage medium.

### 2. Description of the Related Art

Conventionally, a topic analysis device that provides a label corresponding to a topic such as “politics” or “economy” to classification target data such as text data, an image, audio is known (JP 2013-246586 A). The topic analysis device is favorably used in the field of social networking services (SNSs).

The topic analysis device converts the classification target data into vector data, and provides the label on the basis of the converted vector data. The topic analysis device is trained on document data to which a label has been provided in advance.

Although the topic analysis device disclosed in JP 2013-246586 A performs learning processing for a classification unit that classifies data by providing target data with a label, the topic analysis device cannot perform learning processing for a conversion unit that converts the classification target data into the vector data.

According to one aspect of the present invention, conversion unit, which converts data into feature vector, can be efficiently learned.

### SUMMARY OF THE INVENTION

It is an object of the present invention to at least partially solve the problems in the conventional technology.

According to one aspect of an embodiment, a data classification device includes a conversion unit, a classification unit, a first learning unit, and a second learning unit. The conversion unit converts input classification target data into a feature vector. The classification unit provides a label to the classification target data on the basis of the feature vector output by the conversion unit. The first learning unit learns conversion processing of the conversion unit, using accumulated data of the input classification target data, as first learning data. The second learning unit learns classification processing of the classification unit, using second learning data in which a label has been provided to data of a same type as the classification target data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a use environment of a data classification device 100 according to an embodiment;

FIG. 2 is a block diagram illustrating a detailed configuration of the data classification device 100 according to an embodiment;

FIG. 3 is a diagram illustrating an example of a vector representation table TB according to an embodiment;

FIG. 4 is a diagram illustrating an example of a method of calculating a feature vector V according to an embodiment;

FIG. 5 is a diagram for describing label providing processing according to an embodiment;

FIG. 6 is a diagram illustrating an example of first learning data D1 according to an embodiment;

FIG. 7 is a diagram illustrating an example of second learning data D2 according to an embodiment;

FIG. 8 is a flowchart illustrating the label providing processing of an embodiment;

FIG. 9 is a flowchart illustrating learning processing (first learning processing) of learning conversion processing of a feature extractor 130 according to an embodiment;

FIG. 10 is a flowchart illustrating learning processing (second learning processing) of learning classification processing of a classification unit 141 according to an embodiment;

FIG. 11 is a diagram illustrating an example of a hardware configuration of the data classification device 100 according to an embodiment; and

FIG. 12 is a block diagram illustrating a detailed configuration of the data classification device 100 according to another embodiment.

### DETAILED DESCRIPTION OF THE PREFERRED EMBODIMENTS

Hereinafter, embodiments of a data classification device, a data classification method, and a non-transitory computer readable storage medium will be described with reference to the drawings. The data classification device is a device that handles data posted to an SNS in real time as classification target data, and provides a label such as “politics”, “economy”, or “sports” to the data to support classification of the posted data for each theme. The data classification device may be a device that provides a classification result to a server device that manages the SNS or the like by a cloud service or may be built in the server device.

The data classification device converts the classification target data into a feature vector, provides a label on the basis of the feature vector, and learns conversion processing and classification processing, thereby to provide an appropriate label to the classification target data. Note that, in the description below, the feature vector is vector data, and the classification target data is text data including a plurality of words, as an example.

### 1. Use Environment of Data Classification Device

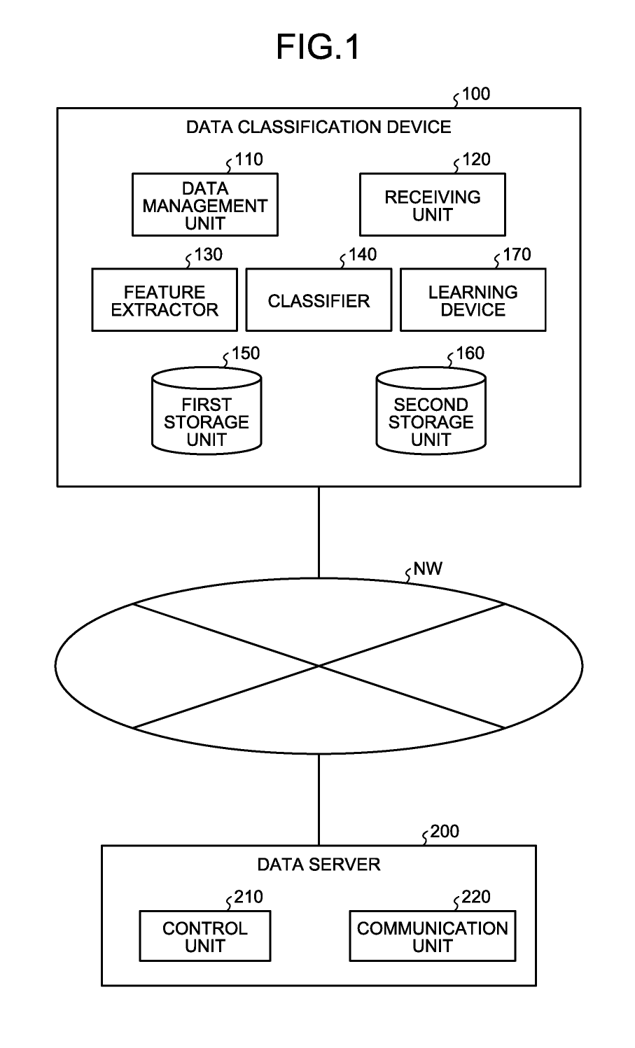

FIG. 1 is a diagram illustrating a use environment of a data classification device 100 according to an embodiment. The data classification device 100 of an embodiment performs communication with a data server 200 through a network NW. The network NW includes a part or all of a wide area network (WAN)), a local area network (LAN), the Internet, a provider device, a wireless base station, a special line, and the like.

The data classification device 100 includes a data management unit 110, a receiving unit 120, a feature extractor 130, a classifier 140, a first storage unit 150, a second storage unit 160, and a learning device 170. The data management unit 110, the feature extractor 130, the classifier 140, and the learning device 170 may be realized by a processor of the data classification device 100 by execution of a program, may be realized by hardware such as a large scale integration (LSI), an application specific integrated circuit (ASIC), or a field-programmable gate array (FPGA), or may be realized by software and hardware in cooperation with each other.

The receiving unit 120 is a device such as a keyboard or a mouse that receives an input from a user. The first storage unit 150 and the second storage unit 160 are realized by a random access memory (RAM), a read only memory (ROM), a hard disk drive (HDD), a flash memory, a hybrid storage device that is a combination of the aforementioned elements, or the like. Further, a part of or all of the first storage unit 150 and the second storage unit 160 may be an external device to which the data classification device 100 is accessible, such as a network attached storage (NAS) or an external storage device.

The data server 200 includes a control unit 210 and a communication unit 220. The control unit 210 may be realized by a processor of the data server 200 by execution of a program, may be realized by hardware such as an LSI, an ASIC, or an FPGA, or may be realized by software and hardware in cooperation with each other.

The communication unit 220 includes a network interface card (NIC), for example. The control unit 210 sequentially transmits stream data to the data classification device 100 through the network NW, using the communication unit 220. The “stream data” is data in order of time, which endlessly arrives in volume, and is an article posted to a blog (weblog) service or an article posted to a social networking service (SNS), for example. Further, the stream data may include sensor data (a position measured by GPS, acceleration, temperature, and the like) provided from various sensors to a control device, or the like. The data classification device 100 uses the stream data received from the data server 200 as the classification target data.

### 2. Label Providing Processing by Data Classification Device

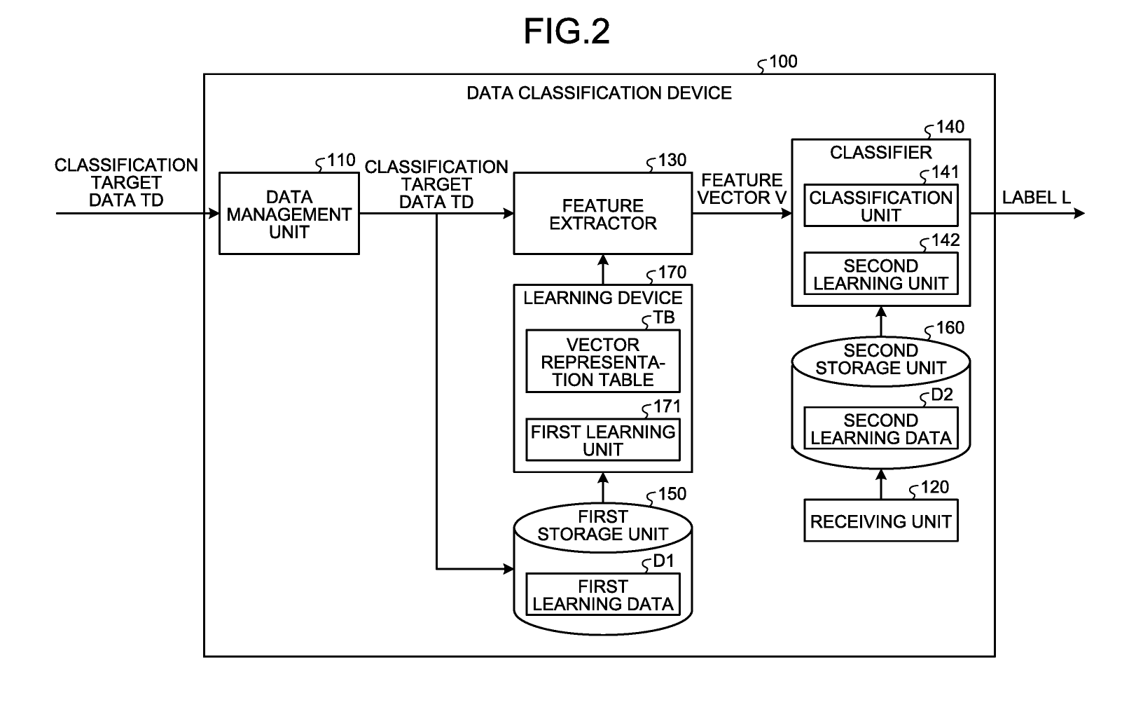

FIG. 2 is a block diagram illustrating a detailed configuration of the data classification device 100 according to an embodiment. The data classification device 100 receives the stream data (hereinafter, referred to as classification target data TD) from the data server 200 and provides a label to the received classification target data TD to classify the classification target data TD. The label is data for classifying the classification target data TD and is data indicating a genre to which the classification target data TD belongs, such as “politics”, “economy”, or “sports”. Hereinafter, a classification operation of the data classification device 100 will be described in detail.

The data management unit 110 receives the classification target data TD from the data server 200, and outputs the received classification target data TD to the feature extractor 130. Further, the data management unit 110 stores the received classification target data TD to the first storage unit 150 as first learning data D1.

The feature extractor 130 extracts a word from the classification target data TD output from the data management unit 110, and converts the extracted word into a vector by reference to a vector representation table TB.

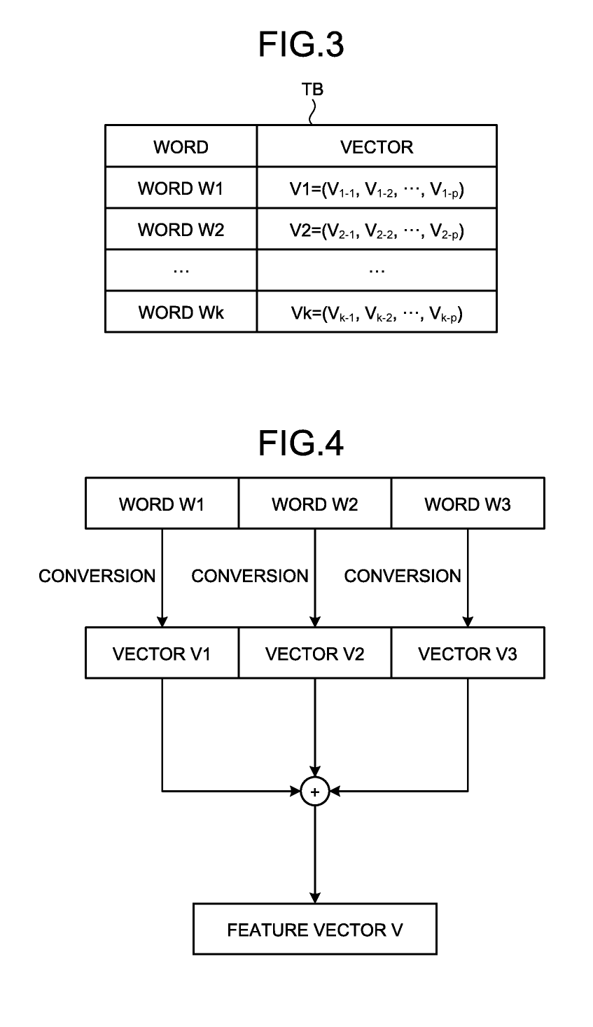

FIG. 3 is a diagram illustrating an example of a vector representation table TB according to an embodiment. The vector representation table TB is stored in a table memory (not illustrated) managed by the learning device 170. In the vector representation table TB, p-dimensional vectors, are respectively associated with k words. The upper limit number k of the words included in the vector representation table TB is favorably and appropriately determined according to a capacity of the table memory. The number of dimensions p of the vector is favorably and appropriately set to a value that is sufficient to accurately classify the data. Note that the vectors included in the vector representation table TB are calculated by learning processing performed by a first learning unit 171 described below.

For example, a vector V1=(V₁₋₁, V₁₋₂, . . . , V₁₋ₚ) is associated with a word W1, a vector V2=(V₂₋₁, V₂₋₂, . . . , V₂₋ₚ) is associated with a word W2, and a vector Vk=(Vₖ₋₁, Vₖ₋₂, . . . , Vₖ₋ₚ) is associated with a word Wk. The feature extractor 130 converts all the words extracted from the classification target data TD into the vectors and adds up all the converted vectors to calculate a feature vector V.

FIG. 4 is a diagram illustrating an example of a method of calculating the feature vector V according to an embodiment. In the example illustrated in FIG. 4, the feature extractor 130 extracts the words W1, W2, and W3 from the classification target data TD. In this case, the feature extractor 130 converts the word W1 into the vector V1, the word W2 into the vector V2, and the word W3 into the vector V3 by reference to the vector representation table TB.

Next, the feature extractor 130 obtains a sum of the vector V1, the vector V2, and the vector V3 to calculate the feature vector V. That is, the example illustrated in FIG. 4 satisfies VD=V1+V2+V3. Therefore, the number of dimensions of the feature vector V is p regardless of the number of words extracted from the classification target data TD.

In this way, the feature extractor 130 converts the classification target data TD input from the data management unit 110 into the feature vector V by reference to the vector representation table TB managed by the learning device 170. After that, the feature extractor 130 outputs the converted feature vector V and the classification target data TD to the classifier 140.

Note that the feature extractor 130 has calculated the sum of the vectors as the feature vector V. However, an embodiment is not limited thereto. For example, the feature extractor 130 may calculate an average vector, which is an average value of the vectors, as the feature vector V, or may calculate any vector as the feature vector V as long as the vector reflects content of the vectors.

The classifier 140 includes a classification unit 141 and a second learning unit 142, and classifies the classification target data TD, using a linear model, for example. When the feature vector V and the classification target data TD are input from the feature extractor 130, the classification unit 141 derives a label corresponding to the input feature vector V, and provides the derived label to the classification target data TD. With this labeling, the classification target data TD is classified. The classification referred here includes classification in a broad sense, such as structure prediction to convert a word sequence into a label sequence. Note that the feature vector V has been input to the classifier 140. However, data may be input to the classifier 140. In this case, the classifier 140 may perform the processing, reflecting data (for example, dates or various parameters to adjust a threshold or the total number of the classification) input other than the feature vector V.

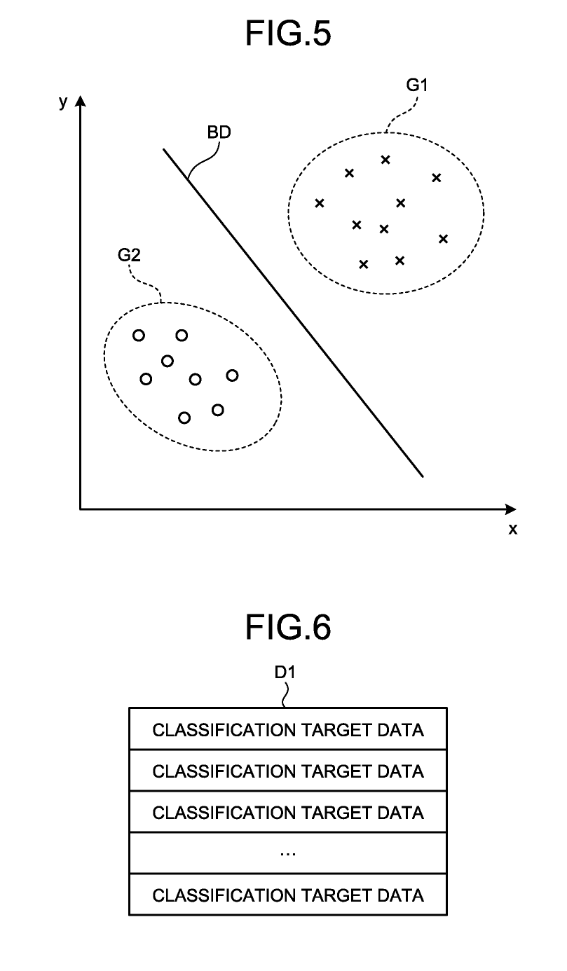

FIG. 5 is a diagram for describing label providing processing according to an embodiment. Here, for simplification of description, an example in which the words are converted into two-dimensional feature vectors (x, y) will be described. In FIG. 5, the horizontal axis represents a value of x of the feature vector and the vertical axis represents a value of y of the feature vector. A group G1 is a group of the feature vector V to which a label L1 is provided. A group G2 is a group of the feature vector V to which a label L2 is provided.

A boundary BD is a classification reference parameter to be used to determine which of the groups G1 and G2 the feature vector V belongs to. Note that the boundary BD is calculated by learning processing performed by the second learning unit 142 described below.

In the example illustrated in FIG. 5, in a case where the feature vector V exists in the upper right of the boundary BD, the classification unit 141 determines that the feature vector V belongs to the group G1, and provides the label L1 to the classification target data TD. Meanwhile, in a case where the feature vector V exists in the lower left of the boundary BD, the classification unit 141 determines that the feature vector V belongs to the group G2 and provides the label L2 to the classification target data TD.

In this way, the classification unit 141 provides the label to the classification target data TD on the basis of the feature vector V output by the feature extractor 130. Further, the classification unit 141 transmits the classification target data TD, which the label has been provided, to the data server 200. For example, the data server 200 uses the classification target data TD, which the label has been provided, and received from the data classification device 100, for classification of genres of articles posted in a blog (weblog) service or classification of genres of articles posted to a social networking service (SNS).

### 3. Learning of Conversion Processing

Next, learning processing of learning conversion processing of the feature extractor 130, the learning processing which is executed by the first learning unit 171, will be described. The first learning unit 171 learns the conversion processing of the feature extractor 130, using accumulated data of the input classification target data TD, as the first learning data D1. In the present embodiment, learning the conversion processing of the feature extractor 130 is updating the vectors V1 to Vk included in the vector representation table TB to have more appropriate values. In the present embodiment, accumulating and processing all the classification target data TD output from the data management unit 110 is inappropriate, and thus the first learning unit 171 performs the learning processing in real time every time receiving a small number of the classification target data TD.

FIG. 6 is a diagram illustrating an example of the first learning data D1 according to an embodiment. In an initial state, the first learning data D1 is not stored in the first storage unit 150. When the data management unit 110 receives the classification target data TD (stream data) from the data server 200, the data management unit 110 stores the received classification target data TD to the first storage unit 150. The data management unit 110 accumulates the received classification target data TD to the first storage unit 150 every time receiving the classification target data TD. Therefore, the classification target data TD is used not only for the conversion processing by the feature extractor 130 but also for the learning processing by the first learning unit 171.

As illustrated in FIG. 6, the first learning data D1 includes a plurality of the classification target data TD received by the data management unit 110. The upper limit number of the classification target data TD included in the first learning data D1 is favorably and appropriately determined according to the capacity of the first storage unit 150. The first learning unit 171 starts the learning processing of learning the conversion processing of the feature extractor 130 when the classification target data TD stored in the first storage unit 150 as the first learning data D1 has reached the upper limit number (in other words, the first learning data D1 stored in the first storage unit 150 has exceeded a predetermined amount).

First, the first learning unit 171 reads one learning data (classification target data) from the first learning data D1 stored in the first storage unit 150. The first learning unit 171 optimizes a loss function, using the stochastic gradient method, for all pairs (t, c) of a word t (target) included in the learning data (classification target data) read from the first storage unit 150 and words c (context) existing near the word t (for example, within five words from the word t). With the optimization, the first learning unit 171 can update the vectors included in the vector representation table TB to have more suitable values.

In the loss function, a word called a negative sample n (negative sample) is used. The negative sample n is a word randomly extracted from a negative sample table (not illustrated) according to a probability P_{α}(n) described in the following formula (1), for the pairs (t, c). Here, f(n) represents the frequency of the word n, and α represents a positive parameter of 1 or less (0<α≦1). As α, 0.75 is often set.

P_{α}(n)∝f(n)^{α} (1)

Further, the first learning unit 171 updates the vector corresponding to the word t, the vector corresponding to the word c, and the vector corresponding to the word n on the basis of the following formulas (2) to (4). Here, the arrow is a sign representing vector representation.

$$\begin{matrix}\vec{t} ← \vec{t} + η \frac{\partial L}{\partial \vec{t}} & ( 2 ) \\ \vec{c} ← \vec{c} + η \frac{\partial L}{\partial \vec{c}} & ( 3 ) \\ \vec{n} ← \vec{n} + η \frac{\partial L}{\partial \vec{n}} & ( 4 )\end{matrix}$$

L in the formulas (2) to (4) represents the loss function. The first learning unit 171 calculates the loss function L on the basis of the following formula (5). Note that, for simplification of description, one negative sample is used in the loss function. However, a plurality of the negative samples may be used.

L(\vec{t}, \vec{c}, \vec{n}=−log σ(\vec{t}·\vec{c})−log σ(−\vec{t}·\vec{n}) (5)

Further, the first learning unit 171 calculates a partial differential value necessary to update the vector corresponding to the word t, the vector corresponding to the word c, and the vector corresponding to the word n, on the basis of the following formulas (6) to (8).

$$\begin{matrix}\frac{\partial L}{\partial \vec{t}} = \{ 1 - σ ( \vec{t} \cdot \vec{c} ) \} \vec{c} - σ ( \vec{t} \cdot \vec{n} ) \vec{n} & ( 6 ) \\ \frac{\partial L}{\partial \vec{c}} = \{ 1 - σ ( \vec{t} \cdot \vec{c} ) \} \vec{t} & ( 7 ) \\ \frac{\partial L}{\partial \vec{n}} = - σ ( \vec{t} \cdot \vec{n} ) \vec{t} & ( 8 )\end{matrix}$$

η in the formulas (2) to (4) represents a learning rate and is a value determined in advance using the stochastic approximation method. To be specific, the first learning unit 171 calculates the learning rate η on the basis of the following formula (9). Here, η₀ is an initial value (for example, 1.0) set in advance, and t is the number of times of update. For example, t=1 is established in a case of the first update, and t=2 is established in a case of the second update.

$$η = \frac{{η}_{0}}{t} \qquad ( 9 )$$

Note that, in the present embodiment, the first learning unit 171 has calculated the learning rate η, using the stochastic approximation method. However, an embodiment is not limited thereto. For example, the first learning unit 171 may calculate the learning rate η, using the AdaGrad method, or the like.

In this way, the first learning unit 171 performs the learning processing of learning the conversion processing of the feature extractor 130 by learning without a supervision, using the first learning data D1 not including information that indicates a positive sample or a negative sample. With the processing, the first learning unit 171 can update the vectors included in the vector representation table TB to have more suitable values.

In a conventional technology, when the learning processing of learning the conversion processing of the feature extractor 130 is performed, batch processing needs to be performed using a large-capacity storage unit that stores data for performing the learning processing after the operation of the classification unit 141 is stopped. Therefore, the learning processing of learning the conversion processing of the feature extractor 130 and the data classification processing cannot be performed in parallel, and thus the learning processing of learning the conversion processing of the feature extractor 130 and the data classification processing cannot be efficiently performed.

In contrast, in the present embodiment, the classification target data TD output from the data management unit 110 is stored in the first storage unit 150 as the first learning data D1. Further, the first learning unit 171 deletes the first learning data (classification target data) from the first storage unit 150 when the learning processing of learning the conversion processing of the feature extractor 130 is completed. When the storage area in the first storage unit 150 is released by the deletion, the data management unit 110 stores the classification target data TD newly received from the data server 200 to the first storage unit 150 as the first learning data. With the storage, the data classification device 100 can perform the learning processing of learning the conversion processing of the feature extractor 130, using the first storage unit 150 having a small storage capacity.

Note that, in the present embodiment, the first learning unit 171 has deleted the first learning data (classification target data) used in the learning processing of learning the conversion processing of the feature extractor 130 from the first storage unit 150. However, an embodiment is not limited thereto. For example, the first learning unit 171 may disable the first learning data (classification target data) used in the learning processing of learning the conversion processing of the feature extractor 130 by providing an “overwritable” flag.

The first learning unit 171 repeatedly performs the above processing, using other learning data (classification target data) included in the first learning data D1. With the processing, the values of the vectors included in the vector representation table TB are optimized. For example, the vectors of the words related to each other are updated to have close values.

In this way, the first learning unit 171 updates a first vector and a second vector included in the vector representation table TB such that the first vector associated with the word t (first word) included in the classification target data TD and the second vector associated with the word c (second word) related to the word t have close values. To be specific, the first learning unit 171 updates the first vector and the second vector included in the vector representation table TB such that the first vector and the second vector have close values in a case where the word c (second word) exists within predetermined words (for example, five words) from the word t (first word) in the classification target data TD. With the update, the first vector and the second vector are uprated to have more suitable values.

Further, the first learning unit 171 calculates the loss function L, using the first vector, the second vector, and the third vector associated with a negative sample, and updates the first vector, the second vector, and the third vector, using a partial differential value of the calculated loss function L. With the calculation, the first vector, the second vector, and the third vector are updated to have more appropriate values.

When a word not included in the vector representation table TB is extracted from the first learning data D1, the first learning unit 171 newly adds the extracted word to the vector representation table TB, and associates the extracted word with a vector set in advance. The vector associated with the newly added word is updated to have more suitable value by the learning processing performed by the first learning unit 171.

Here, when the total number of the words registered in the vector representation table TB has reached the upper limit number, the first learning unit 171 deletes a word having a low frequency of appearance from the vector representation table TB, and adds the newly extracted word to the vector representation table TB. With the processing, an overflow of the table memory that stores the vector representation table TB due to the increase in the number of words can be prevented.

### 4. Learning of Classification Processing

Next, learning processing of learning the classification processing of the classification unit 141, the learning processing being executed by the second learning unit 142, will be described. The second learning unit 142 learns the classification processing of the classification unit 141, using second learning data D2 in which a label has been provided to data of the same type as the classification target data TD. In the present embodiment, learning the classification processing of the classification unit 141 is updating the classification reference parameter (the boundary BD in FIG. 5, for example) to be used to classify the feature vector V to be a more appropriate parameter.

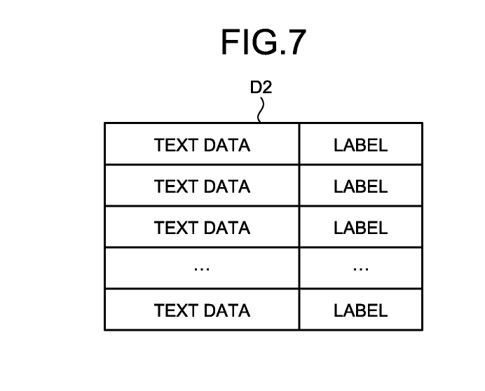

FIG. 7 is a diagram illustrating an example of the second learning data D2 according to an embodiment. The user inputs text data including a sentence and a label (correct data) corresponding to the text data to the data classification device 100. The receiving unit 120 receives the text data and the label (correct data) input by the user, and stores the text data and the label to the second storage unit 160, as the second learning data D2. As described above, the second learning data D2 is data created by the user and stored in the second storage unit 160, and may not be increased by being input as needed, unlike the first learning data D1.

As illustrated in FIG. 7, the second learning data D2 includes a plurality of learning data in which the text data and the label are associated with each other. The upper limit number of the learning data included in the second learning data D2 is favorably and appropriately determined according to a capacity of the second storage unit 160. The second learning unit 142 starts the learning processing for the classification unit 141 when the vectors included in the vector representation table TB has been updated by the first learning unit 171, for example.

First, the second learning unit 142 reads the learning data (the text data and the label) from the second learning data D2 stored in the second storage unit 160. Here, the number of the learning data read by the second learning unit 142 is appropriately determined according to the frequency of the learning processing performed by the second learning unit 142. For example, the second learning unit 142 may read one learning data in a case where the learning processing is frequently performed, or may read all the learning data from the second storage unit 160 in a case where the learning processing is occasionally performed. The second learning unit 142 outputs the text data included in the read learning data to the feature extractor 130. The feature extractor 130 converts the text data output from the second learning unit 142 into the feature vector V by reference to the vector representation table TB managed by the learning device 170. After that, the feature extractor 130 outputs the converted feature vector V to the classifier 140.

Next, the second learning unit 142 updates the classification reference parameter (the boundary BD of FIG. 5), using the feature vector V input from the feature extractor 130 and the label (correct data) included in the learning data read from the second storage unit 160. The second learning unit 142 may calculate the classification reference parameter, using any of techniques that have been conventionally performed. For example, the second learning unit 142 may optimize the hinge loss function of the support vector machine (SVM) by the stochastic gradient method to calculate the classification reference parameter or may calculate the classification reference parameter, using a perceptron algorithm.

The second learning unit 142 sets the calculated classification reference parameter to the classification unit 141. The classification unit 141 performs the above-described classification processing, using the classification reference parameter set by the second learning unit 142.

In this way, the second learning unit 142 updates the classification reference parameter (the boundary BD in FIG. 5, for example) to be used to classify the feature vector V converted by the feature extractor 130, on the basis of the second learning data D2 including information indicating a positive sample or a negative sample. To be specific, the second learning unit 142 reads the second learning data D2 to which the label has been provided from the second storage unit 160, and outputs the read second learning data D2 to the feature extractor 130. The feature extractor 130 converts the second learning data D2 output from the second learning unit 142 into the feature vector V, and outputs the converted feature vector V to the second learning unit 142. The second learning unit 142 updates the classification reference parameter on the basis of the feature vector V output from the feature extractor 130 and the label provided to the second learning data D2. With the update, the classification reference parameter (the boundary BD in FIG. 5) to be used to classify the feature vector V can be updated to be a more suitable value.

Note that the second learning unit 142 does not delete the learning data (the text data and the label) used in the learning from the second storage unit 160 even when the learning processing of learning the classification processing of the classification unit 141 is completed. That is, the second learning unit 142 repeatedly uses the second learning data D2 accumulated in the second storage unit 160 in performing the learning processing of learning the classification processing of the classification unit 141. With this configuration, the second learning unit 142 being unable to perform the learning processing due to emptiness of the second storage unit 160 can be prevented.

Note that the second learning unit 142 may provide a flag to the second learning data used in the learning processing of learning the classification processing of the classification unit 141, and delete the data to which the flag has been provided. With the processing, an overflow of the second storage unit 160 can be prevented.

The second learning unit 142 repeatedly performs the learning processing, using another learning data (another text data and label) included in the second learning data D2 every time the learning processing by the first learning unit 171 is performed. The second learning data D2 is data to which the label (correct data) input by the user has been provided. Therefore, the second learning unit 142 can improve accuracy of the classification processing performed by the classification unit 141 every time performing the learning processing for the classification unit 141, using the second learning data D2.

Note that the processing by the feature extractor 130 and the classification unit 141 is executed in asynchronization with the processing by the first learning unit 171 and the second learning unit 142. With the configuration, the learning processing of learning the conversion processing of the feature extractor 130, the learning processing of learning the classification processing of the classification unit 141, and the data classification processing can be efficiently performed.

If a technology to sequentially learning vector representation exists, reading the learning data one by one and performing the learning processing in real time, and updating again the vector corresponding to the once-learned word are difficult. However, the first learning unit 171 of the present embodiment can be operated in real time in parallel to the processing by the feature extractor 130 and the classification unit 141 even in a case of reading the learning data one by one from the first storage unit 150. Further, the first learning unit 171 of the present embodiment can update again the vectors in the once-updated vector representation table TB to have more suitable values, every time performing learning using the first learning data D1.

### 5. Flowchart of Label Providing Processing

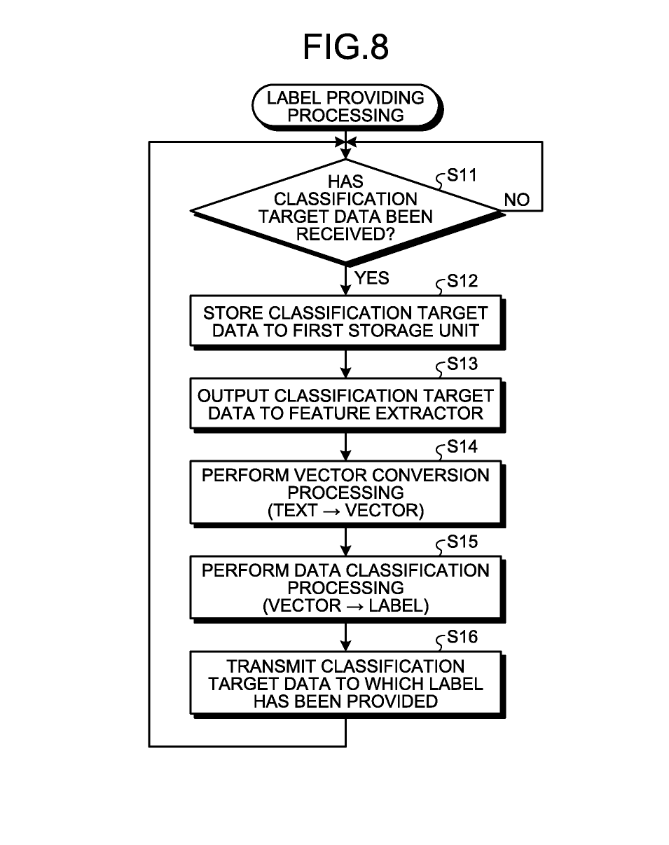

FIG. 8 is a flowchart illustrating the label providing processing of an embodiment. The processing by the present flowchart is executed by the data classification device 100.

First, the data management unit 110 determines whether having received the classification target data TD from the data server 200 (S11). When the data management unit 110 has determined the reception of the classification target data TD from the data server 200, the data management unit 110 stores the received classification target data TD to the first storage unit 150, as the first learning data D1 (S12).

Next, the data management unit 110 outputs the received classification target data TD to the feature extractor 130 (S13). The feature extractor 130 converts the classification target data TD input from the data management unit 110 into the feature vector V by reference to the vector representation table TB managed by the learning device 170 (S14). The feature extractor 130 outputs the converted feature vector V to the classification unit 141.

The classification unit 141 provides the label to the classification target data TD on the basis of the feature vector V input from the feature extractor 130 and the classification reference parameter (the boundary BD in FIG. 5) to classify the classification target data TD (S15). The classification unit 141 transmits the classification target data TD to which the label has been provided to the data server 200 (S16), and returns the processing to the above-described S11.

### 6. Flowchart of First Learning Processing

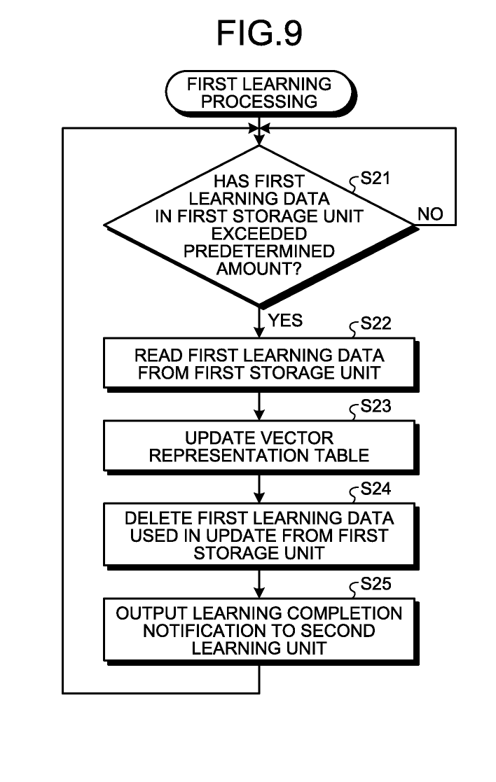

FIG. 9 is a flowchart illustrating the learning processing (first learning processing) of the learning conversion processing of the feature extractor 130 according to an embodiment. The processing by the present flowchart is executed by the first learning unit 171.

First, the first learning unit 171 determines whether the first learning data D1 in the first storage unit 150 has exceeded a predetermined amount (S21). When the first learning unit 171 has determined that the first learning data D1 in the first storage unit 150 has exceeded the predetermined amount, the first learning unit 171 reads out the first learning data D1 from the first storage unit 150 (S22).

Next, the first learning unit 171 updates the vector representation table TB, using the read first learning data D1 (S23). With the processing, the vectors included in the vector representation table TB can be updated to have more suitable values. Next, the first learning unit 171 deletes the first learning data D1 used in the update from the first storage unit 150 (S24). After that, the first learning unit 171 outputs learning completion notification notifying completion of the first learning processing to the second learning unit 142 (S25), and returns the processing to the above-described S21.

### 7. Flowchart of Second Learning Processing

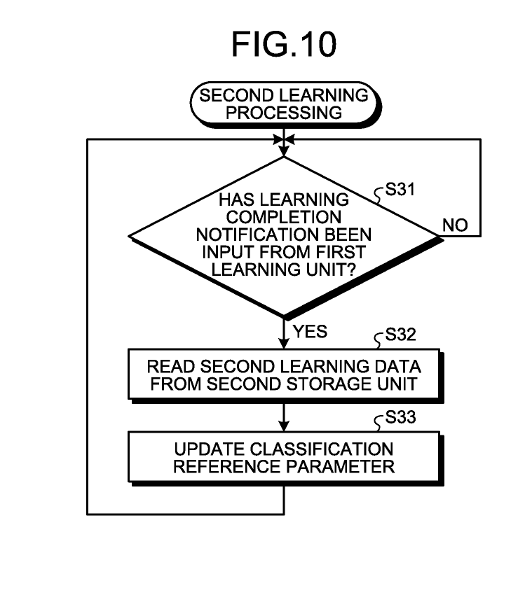

FIG. 10 is a flowchart illustrating the learning processing (second learning processing) of the learning classification processing of the classification unit 141 according to an embodiment. The processing by the preset flowchart is executed by the second learning unit 142.

First, the second learning unit 142 determines whether the learning completion notification has been input from the first learning unit 171 (S31). When the second learning unit 142 has determined the input of the learning completion notification from the first learning unit 171, the second learning unit 142 reads the second learning data D2 from the second storage unit 160 (S32).

Next, the second learning unit 142 updates the classification reference parameter (for example, the boundary BD in FIG. 5), using the read second learning data D2 (S33). With the processing, the accuracy of the classification processing performed by the classification unit 141 can be improved. After that, the second learning unit 142 returns the processing to the above-described S31.

Note that the data classification device 100 executes the processing by the flowchart illustrated in FIG. 8, the flowchart by the flowchart illustrated in FIG. 9, and the processing by the flowchart illustrated in FIG. 10 in parallel. With the configuration, the data classification device 100 can execute the learning processing of learning the conversion processing of the feature extractor 130 and the learning processing of learning the classification processing of the classification unit 141 without stopping the label providing processing. Therefore, the data classification device 100 can efficiently perform the learning processing of learning the conversion processing of the feature extractor 130, the learning processing of learning the classification processing of the classification unit 141, and the data classification processing.

### 8. Hardware Configuration

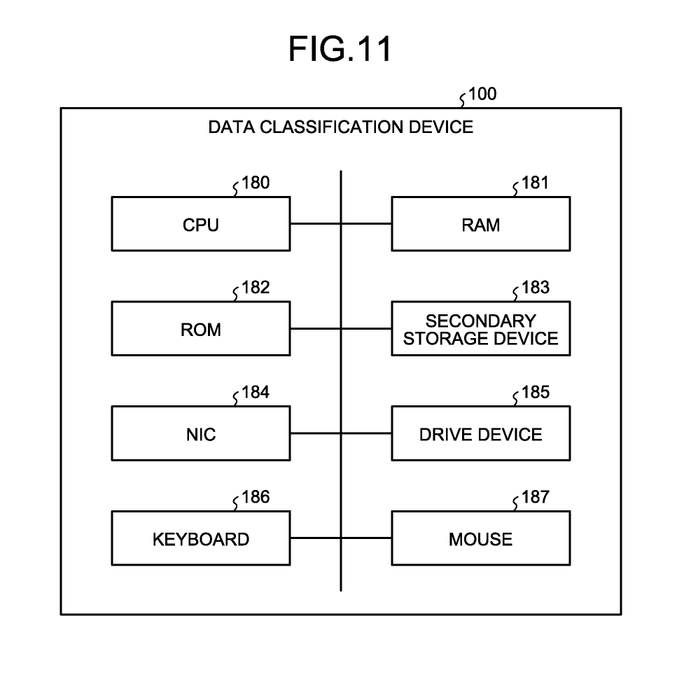

FIG. 11 is a diagram illustrating an example of a hardware configuration of the data classification device 100 according to an embodiment. The data classification device 100 has a configuration in which a CPU 180, a RAM 181, a ROM 182, a secondary storage device 183 such as a flash memory or an HDD, an NIC 184, a drive device 185, a keyboard 186, and a mouse 187 are connected with one another by an internal bus or a special communication line. A potable storage medium such as an optical disk is mounted to the drive device 185. A program stored in the secondary storage device 183 or the portable storage medium mounted to the drive device 185 is expanded to the RAM 181 by a direct memory access (DMA) controller (not illustrated) or the like and executed by the CPU 180, thereby to realize the function units of the data classification device 100.

Note that, in the present embodiment, the classification target data TD received by the data management unit 110 has been input to the feature extractor 130 and stored to the first storage unit 150, as the first learning data D1. However, an embodiment is not limited thereto. For example, the input of the classification target data TD to the feature extractor 130 and the input of the classification target data TD to the first storage unit 150 may be separate systems.

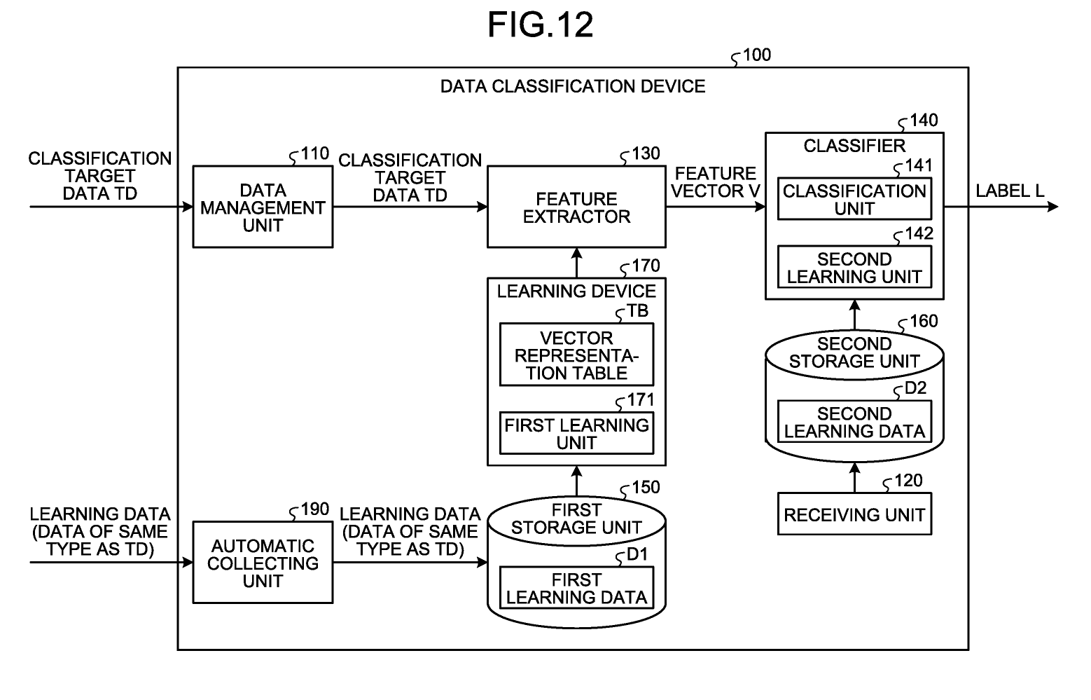

FIG. 12 is a block diagram illustrating a detailed configuration of a data classification device 100 according to another embodiment. As illustrated in FIG. 12, the data classification device 100 further includes an automatic collecting unit 190 that automatically connects learning data of the same type as classification target data TD, and the automatic collecting unit 190 may store the collected learning data to a first storage unit 150, as first learning data D1. In this way, the data classification device 100 may include the automatic collecting unit 190 that stores the collected learning data to the first storage unit 150, as the first learning data D1, separately from a data management unit 110 that inputs the classification target data TD to a feature extractor 130.

Further, the data classification device 100 has classified the classification target data TD as the text data and has provided the label. However, an embodiment is not limited thereto. For example, the data classification device 100 may classify classification target data TD as audio data and provide a label, or may classify classification target data TD as image data and provide a label. In a case where the data classification device 100 classifies the image data, the feature extractor 130 may convert the input image data into vector representation, using Auto-Encoder, or a first learning unit 171 may optimize Auto-Encoder, using the stochastic gradient method. Further, a neural network using a pixel of the image data as an input may be used in place of a vector representation table TB.

Further, the first learning unit 171 has started the learning processing of learning the feature extractor 130 when the first learning data D1 stored in the first storage unit 150 exceeds the predetermined amount. However, an embodiment is not limited thereto. For example, the first learning unit 171 may start the learning processing of learning the feature extractor 130, before the first learning data D1 stored in the first storage unit 150 exceeds the predetermined amount. Further, the first learning unit 171 may start the learning processing of learning the feature extractor 130 in a case where the first storage unit 150 becomes full.

Further, the feature extractor 130 has converted the word into the vector. However, the feature extractor 130 may convert the word into another feature vector. Further, the feature extractor 130 has referred the vector representation table TB in converting the word into the feature vector. However, the feature extractor 130 may refer to another information source.

As described above, according to the data classification device 100 of an embodiment, the first learning unit 171 learns the conversion processing of the feature extractor 130, using the accumulated data of the classification target data TD as the first learning data D1, and the second learning unit 142 learns the classification processing of the classification unit 141, using the second learning data D2 in which the label has been provided to the data of the same type as the classification target data TD. With the configuration, the data classification device 100 can efficiently learn the conversion processing of converting data into feature vector.

Note that the present invention has been applied to the data classification device 100. However, the present invention may be applied to another information processing apparatus. For example, the present invention may be applied to a learning apparatus that includes a conversion unit that converts processing target data into a feature vector, using a vector representation table, and a learning unit that learns the conversion processing of the conversion unit. For example, a synonym retrieval system having a learning function is realized by the learning apparatus and a synonym retrieval device that performs synonym retrieval using a vector representation table.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data classification device comprising:
a conversion unit that converts input classification target data into a feature vector;
a classification unit that provides a label to the classification target data on the basis of the feature vector output by the conversion unit;
a first learning unit that learns conversion processing of the conversion unit, using accumulated data of the input classification target data, as first learning data; and
a second learning unit that learns classification processing of the classification unit, using second learning data in which a label has been provided to data of a same type as the classification target data.

2. The data classification device according to claim 1, wherein
the conversion unit converts the classification target data into vector data as the feature vector by reference to a vector representation table in which a word and a vector are associated, and
the first learning unit updates the vector included in the vector representation table, using the first learning data not including information indicating a positive sample or a negative sample.

3. The data classification device according to claim 2, wherein
the first learning unit updates a first vector associated with a first word included in the classification target data and a second vector associated with a second word related to the first word such that the first vector and the second vector included in the vector representation table have close values.

4. The data classification device according to claim 3, wherein
the second word related to the first word is a word existing within predetermined words from the first word in the classification target data.

5. The data classification device according to claim 3, wherein
the first learning unit calculates a loss function, using the first vector, the second vector, and a third vector associated with a negative sample, and updates the first vector, the second vector, and the third vector, using a partial differential value of the calculated loss function.

6. The data classification device according to claim 1, wherein
the second learning unit updates a classification reference parameter to be used to classify the feature vector output by the conversion unit, on the basis of the second learning data including information indicating a positive sample or a negative sample.

7. The data classification device according to claim 6, wherein
the second learning unit outputs the second learning data to the conversion unit,
the conversion unit converts the second learning data output from the second learning unit into the feature vector, and outputs the feature vector to the second learning unit, and
the second learning unit updates the classification reference parameter on the basis of the feature vector output from the conversion unit and the label provided to the second learning data.

8. The data classification device according to claim 1, wherein
processing by the conversion unit and the classification unit is executed in asynchronization with processing by the first learning unit and the second learning unit.

9. The data classification device according to claim 1, wherein
the first learning data is stored in a first storage unit,
the first learning unit starts learning processing of learning conversion processing of the conversion unit when the first learning data stored in the first storage unit has exceeded a predetermined amount.

10. The data classification device according to claim 9, wherein
the first learning unit deletes or disables the first learning data from the first storage unit when the learning processing of learning conversion processing of the conversion unit has been completed.

11. A data classification device comprising:
a conversion unit that converts input classification target data into a feature vector;
a classification unit that provides a label to the classification target data on the basis of the feature vector output by the conversion unit; and
a learning unit that learns conversion processing of the conversion unit, using accumulated data of the input classification target data, as learning data.

12. A data classification method comprising:
a conversion step of converting input classification target data into a feature vector;
a classification step of providing a label to the classification target data on the basis of the feature vector output by the conversion step;
a first learning step of learning conversion processing of the converting step, using accumulated data of the input classification target data, as first learning data; and
a second learning step of learning classification processing of the classification step, using second learning data in which a label has been provided to data of a same type as the classification target data.

13. A non-transitory computer readable storage medium having stored therein a control program causing a computer to execute a process, the process comprising:
a conversion unit that converts input classification target data into a feature vector;
a classification unit that provides a label to the classification target data on the basis of the feature vector output by the conversion unit; and
a first learning unit that learns conversion processing of the conversion unit, using accumulated data of the input classification target data, as first learning data; and
a second learning unit that learns classification processing of the classification unit, using second learning data in which a label has been provided to data of a same type as the classification target data.
